(19) United States
(12) Patent Application Publication
(10) Pub. No.: US 2003/0068094 A1
(43) Pub. Date: Apr. 10, 2003

(54) Image processing with keystone correction of the digital image data for projector

(75) Inventors: Keishi Kimura, Matsumoto-Shi (JP); Takahiro Amari, Shiojiri-Shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/231,235

(22) Filed: Aug. 30, 2002

(30) Foreign Application Priority Data
Sep. 5, 2001 (JP) 2001-268381

(51) Int. Cl. G06T 3/00; G06T 5/00; G03B 21/00

(52) U.S. Cl. 382/274; 382/293; 353/70

(57) ABSTRACT

A projector in accordance with the invention includes an image processing unit that includes an image quality adjustment unit and a keystone correction unit. The image processing unit corrects the keystone error, in which a distorted image data is generated and a black part is added to the distorted image, after the image quality adjustment, such as brightness adjustment, is performed for the input digital image data. This processing order reduces or prevents the black part from being affected by the brightness adjustment and becoming a gray part, thereby enhancing the quality of the projected image.

### BACKGROUND OF THE INVENTION

1. Field of Invention

This invention relates to image processing with keystone correction of digital image data supplied to a projector.

2. Description of Related Art

A projector modulates incident light from a light source by a light valve, such as a liquid crystal panel (hereafter “LCP”), based on image data, projects the modulated light by using a projection optical unit onto a screen, and thereby displays an image. Tilted projection is sometimes taken so as to avoid an obstacle that is disposed between the apparatus and the screen hindering appreciation of the projected image. Some projectors can correct the keystone error caused by the tilted projection.

FIGS. 3-5 are schematics that show the image projected by a projector 100. The side view of the projector 100 and screen SC are shown at the left side of FIGS. 3-5. The image P formed to LCP in the projector 100 is also shown at the upper part of FIGS. 3-5. The projected image on the screen SC is shown at the right side of FIGS. 3-5.

FIG. 3 shows the projected image without a tilted projection, that is, in the case where an elevation angle, which is the angle between the optical axis of the projector 100 and the normal line of the screen SC, is 0. In this case, no keystone error appears on the projected image P1 of the image P formed in the LCP.

FIG. 4 shows the projected image with a tilted projection, that is, in the case where the elevation angle θ is not 0. In this case, keystone error appears on the projected image P2.

FIG. 5 shows the projected image with a tilted projection and keystone correction. Keystone correction generated corrected image CP including distortion image Ra(P) which has reversed trapezoidal shape of the projected image with keystone error P2, and adding black image Rb, its tone value being set 0, illustrated with hatching in FIG. 5. The correction generating such a corrected image CP enables the image to be projected in the correct shape. The black image Rb is not substantially showed as image Rb1 in the projected image CP1 on the screen SC.

Some related art projectors can now input not only analog image data but also various digital image data. The digital image data includes the data by a transmission standard called TMDS (Transition Minimized Differential Signaling) based on DVI (Digital Visual Interface) standard. The projector performs various image processing of this image data, thereby achieving a user's desired image quality.

FIG. 6 schematically shows the flow of the digital image data in such a related art projector. Here, TMDS data is supposed to be input. The TMDS data is input to the receiver 110, converted into 8 bits data of R, G, and B color, corrected the keystone error by the keystone correction unit 120, adjusted the image quality by the quality adjustment unit 130, and supplied to LCP driver 140. The adjustment of brightness, contrast, sharpness, shade and such is included in the image quality adjustment. Thus, the image quality adjustment has so far been generally performed after the keystone correction.

In the keystone correction, the black image Rb is added to the distorted image of the original image, as described above. When the brightness is enhanced after the keystone correction, the brightness of the black image Rb is also enhanced and its color becomes gray. The gray part Rb is easily viewed by audiences even though it should not be projected, and this damages the projected image.

Similar problems occurred when other image quality adjustments are performed, because they affect not only the digital image data but also the black image Rb. Accordingly, in the related art projector, the image quality adjustment does not effectively enhance the image quality as a whole.

### SUMMARY OF THE INVENTION

This invention addresses or solves the above-mentioned problem, and thereby provides effective image processing with keystone correction to the digital image data supplied to the projector.

This invention provides an image processing apparatus that executes an image processing to original image data and generates image data for a projector. The image processing apparatus includes: an input unit configured to input digital image data, a quality adjustment unit configured to execute an adjustment of image quality to the digital image data, and a keystone correction unit configured to generate corrected image data so as to correct a keystone error which occurs by a tilted projection of the projector from the digital image data which is adjusted the image quality.

The digital data to be input includes: TMDS, LVDS (Low Voltage Differential Signaling), GVIF (Gigabit Video Interface), and SDI (Serial Digital Interface). The digital data converted from an analog signal is acceptable.

In this invention, the image quality is adjusted in the former steps of keystone correction. It reduces or prevents the image quality adjustment from affecting a black part, which is added by the keystone correction and should not be projected. As a result, this invention provides effective image processing to the digital image data even when the keystone correction is accompanied.

The quality adjustment unit in the image processor of this invention can provide various image quality adjustments. One of the preferable adjustments is brightness adjustment.

In this case, this invention effectively reduces or avoids the problem where the black part, which should not be projected, becomes gray and is easily viewed by performing the brightness adjustment before the keystone correction.

It is also desirable to perform the image quality adjustment before the keystone correction. The image quality adjustment can include a sharpness adjustment besides the brightness adjustment where the tone value of a processing pixel affects the tone value of the pixels around the processing pixel. This reduces or prevents the image to be projected from being affected by the black part added by the keystone correction.

In the case where the digital image data includes plural color data of which colors are different from each other, the adjustment of image quality can be independently performed for each color.

The invention achieves flexible adjustment of the tint, thereby enhancing the convenience of the image processing apparatus.

This invention can include a projector that includes an image formation part and an projection optical unit with the above-mentioned image processing apparatus.

This invention can include a method of image processing besides the above-mentioned image processing apparatus and the projector. Moreover, this invention can be configured in various manners, such as a computer program which executes above-mentioned image processing, a recording medium which records the computer program, and a carrier wave to carry the computer program. In each embodiment, various features described above can be applied.

When this invention is configured as a computer program or a recording medium which records the computer program, the computer program may include program codes corresponding to whole function of the image processing apparatus or only a portion of those functions. Various media is available as the recording medium, such as the internal and external storage like RAM and ROM, the printed matters on which signs like bar codes are printed, flexible disks, CD-ROMs, the magnet-optical disks, the integrated circuit cards, ROM cartridges, the punched cards, and other computer readable mediums, for example.

### BRIEF DESCRIPTION OF THE DRAWINGS

FIG. 1 is a schematic that shows the construction of projector 10 as an embodiment of this invention;

FIG. 2 is a flow chart of the image processing performed by the image processing unit 20;

FIG. 3 is a schematic that shows the projected image without a tilted projection;

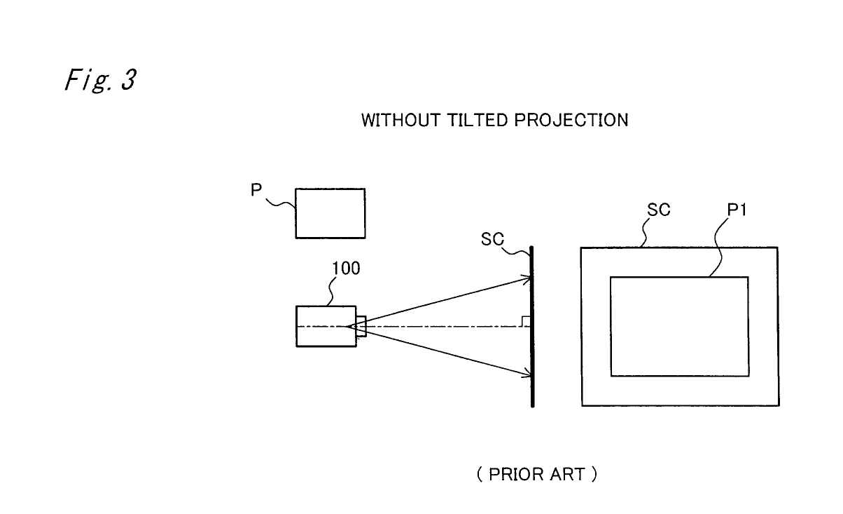

FIG. 4 is a schematic that shows the projected image with a tilted projection;

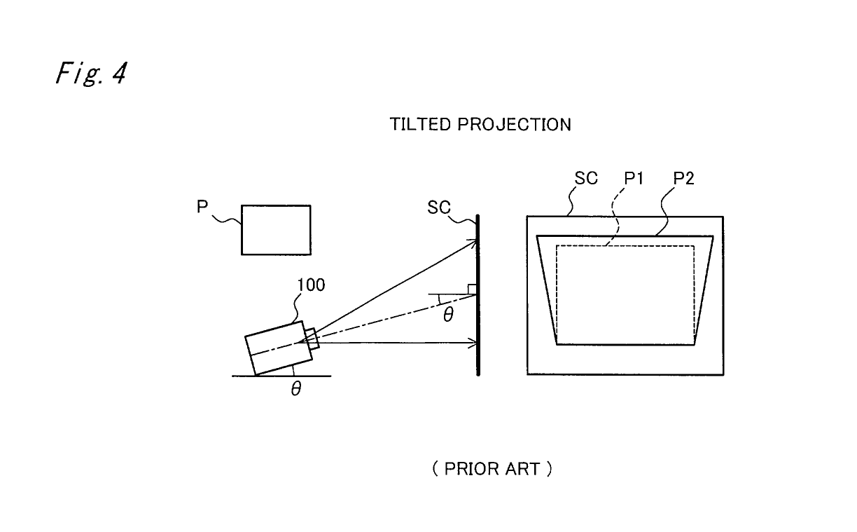

FIG. 5 is a schematic that shows the projected image with a tilted projection and keystone correction; and

FIG. 6 is a schematic that shows the flow of the digital image data in a related art projector.

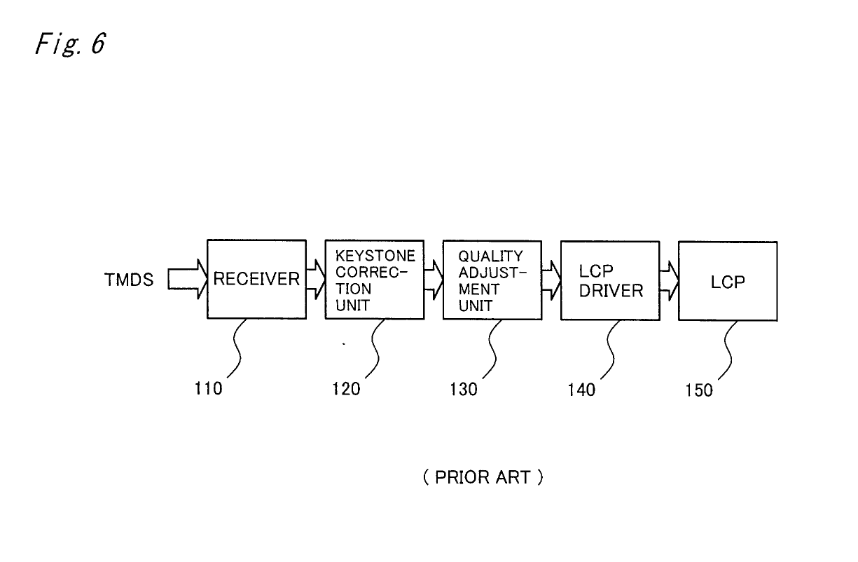

### DETAILED DESCRIPTION OF PREFERRED EMBODIMENTS

Preferred embodiments of this invention are described in the following order.

A. Construction of projector:

B. Image processing:

C. Modification:

A. Construction of Projector:

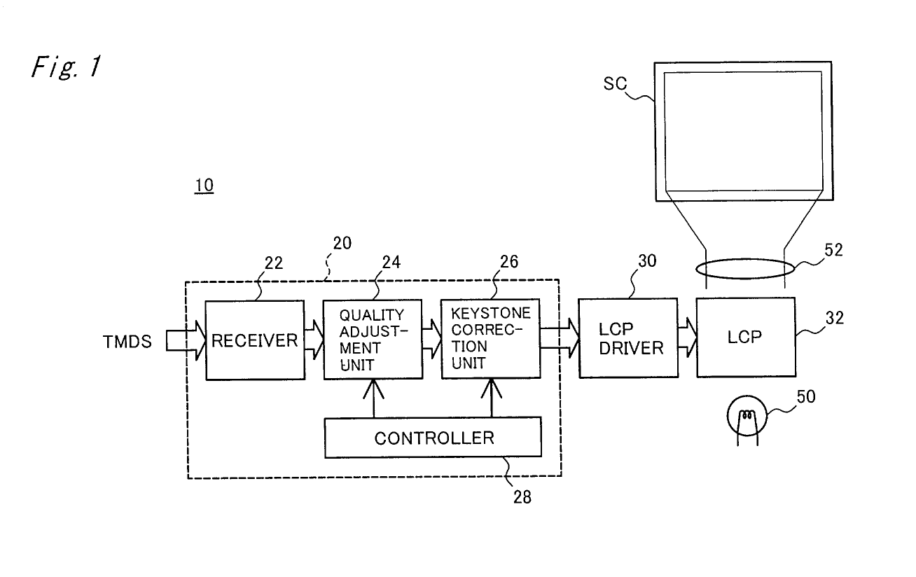

FIG. 1 is a schematic that shows the construction of projector 10 as an embodiment of this invention. The projector 10 includes an image processing unit 20, a LCP driver 30, and a LCP 32. This projector 10 also has a lighting unit 50 to illuminate LCP 32 and a projection optical unit 52 which projects transmitted light through the LCP 32 onto a screen SC.

The image processing unit 20 performs an image processing described below to input image data, thereby generating corrected image data. LCP driver 30 generates a driving signal to drive LCP 32 based on the corrected image data. LCP 32 modulates the illumination light according to this driving signal. The transparent type LCP may be applied to the LCP 32, which is used as a light valve or an optical modulator to modulate the illumination light from the lighting unit 50. The LCP 32 corresponds to the image formation unit of this invention. The lighting unit 50 and the projection optical unit 52 correspond to the projection optical unit of this invention.

This projector 10 includes three for three LCP 32 corresponding to RGB colors, although they are not shown. Moreover, each circuit described below can process the image data for those three colors. The lighting unit 50 includes a color separation unit by which the white light is separated to those three colors. Moreover, the projection optical unit 52 includes a synthetic optical system which synthesizes the three colors and generates image light to project a color image.

B. Image Processing:

The image processing unit 20 includes a receiver 22, a quality adjustment unit 24, a keystone correction unit 26, and a control unit 28. In this embodiment, the receiver 22 is an exclusive-use receiver that inputs the TMDS digital data. Another type of receiver can be used to input various type of digital image data or YUV data including luminance signals (Y), the difference between the luminance signal and a red element (U), and the difference between the luminance signal and a blue element (V). Moreover, a receiver to input analog image data is available. The receiver 22 converts the input digital data into RGB tone value data with 8 bits (256 tone values), and provides them to the quality adjustment unit 24.

The quality adjustment unit 24 adjusts the image quality of the supplied data according to the image quality setting by the user. The adjustment can be applied to brightness, contrast, and sharpness, shade, and such. These adjustments can be applied to respective colors of RGB, which achieves a flexible adjustment of the image quality and enhances the convenience of the projector. In this embodiment, the brightness adjustment is supposed to be applied as the image quality adjustment.

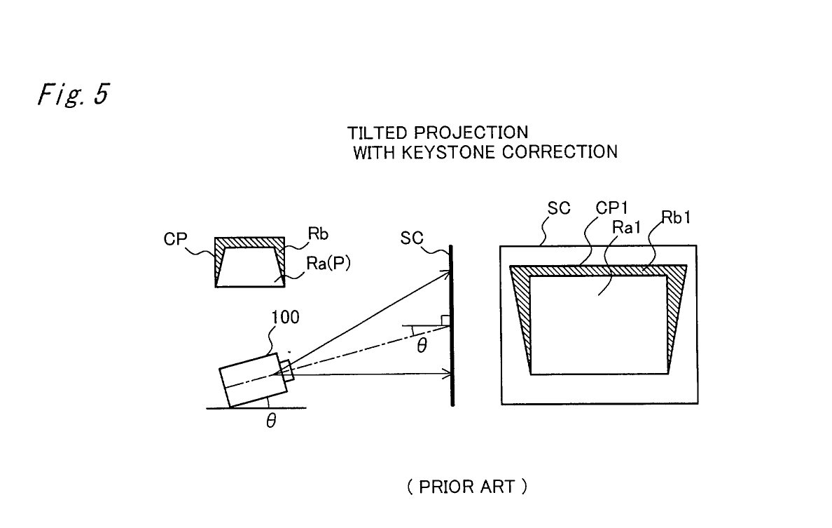

The keystone correction unit 26 generates the corrected image data from the data after the brightness correction so as to correct a keystone error of the projected image, which occurs with tilted projection by the projector 10. The keystone correction is performed, as explained with reference to FIG. 5, by generating a distorted image which is distorted in the opposite direction to the keystone error and adding a black image around the distorted image. This processing is in accordance with the elevation angle, which is the angle between the optical axis of the projector 10 and the normal axis of the screen SC. Since the quality adjustment unit 24 and the keystone correction unit 26 are well-known, a detailed explanation thereof is omitted.

Various parameter values used for the processing in the quality adjustment unit 24 and the keystone correction unit 26 can be input to the controller 28 by the user through operations of the keys installed to the projector 10 or a remote controller (not shown in FIG. 1). The elevation angle may be automatically detected by a sensor installed in the projector 10, and be input as a parameter value to the keystone correction unit 26. Control unit 28 controls processing in the quality adjustment unit 24 and the keystone correction unit 26 according to the input parameter values.

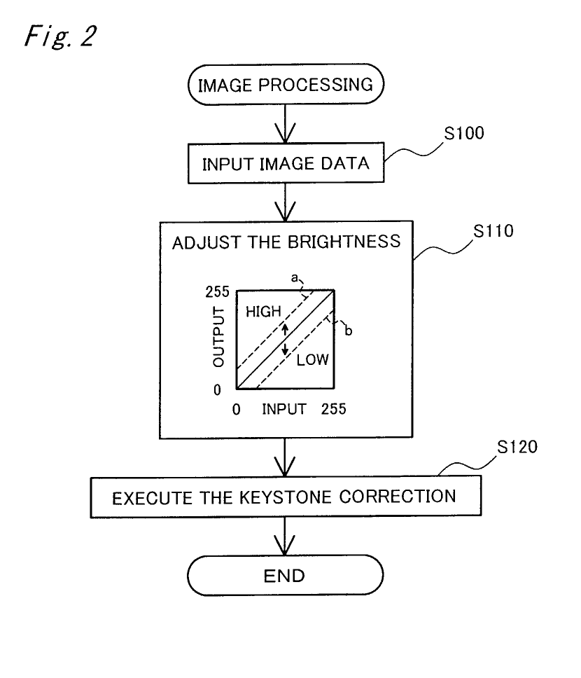

FIG. 2 is a flow chart of the image processing performed by the image processing unit 20. First of all, the image processing unit 20 inputs the TMDS digital image data (step S100), and converts them into RGB tone value data with 8 bits each (0-255 tone values). Next, the image processing unit 20 performs the brightness adjustment based on the image quality setting by the user (step S110). One example of the tone curve for the brightness adjustment is shown in FIG. 2. The tone curve can be arbitrarily set: the steeper tone curve (broken line a) enhances the brightness; the rather gradual tone curve (broken line b) weakens the brightness. The tone curve can be set corresponding to respective color of RGB, even though only one tone curve is shown here. Other image quality adjustments besides the brightness adjustment may be applied. At the end of this process, the image processing unit 20 executes the keystone correction according to the elevation angle, thereby generating the corrected image data (step S120).

In the related art process, the bright adjustment is performed after the keystone correction. That causes a problem where the black part added by keystone correction, which should not be projected, is affected by the adjustment and is projected in gray color. The image quality adjustment is performed in advance of the keystone correction, and the projector 10 of this embodiment prevents the black part from being affected by the brightness adjustment. Accordingly, the input digital image data can be effectively corrected for the keystone error and projected.

C. Modification:

This invention is not limited to the above-described embodiment, and can encompass various embodiments while not deviating from the spirit of the invention. For instance, the following exemplary modifications are available.

C1. Modification 1:

The image quality adjustment is not limited to the brightness adjustment explained in the above-mentioned embodiment. For instance, this invention is also effective when the sharpness adjustment is performed as the image quality adjustment, because the tone value of the processing object pixel is affected by the tone value for the sharpness adjustment. Performing the sharpness adjustment in advance of the keystone correction reduces or prevents the image to be projected from being subject to the influence of the black part added by the keystone correction.

C2. Modification 2:

Various types of projectors are applicable to this invention, even though the transparent type LCP is applied in the above-mentioned embodiment, such as a projector with a reflective type LCP, a digital micro-mirror device (trademark of the Texas Instruments Company) and CRT, for example.

What is claimed is:

1. An image processing apparatus that executes image processing to original image data and generates image data for a projector, the image processing apparatus comprising:
an input unit configured to input digital image data;
a quality adjustment unit configured to execute an adjustment of image quality to the digital image data; and
a keystone correction unit configured to generate corrected image data so as to correct a keystone error, which occurs by a tilted projection of the projector, of the digital image data which is adjusted for image quality.

2. The image processing apparatus according to claim 1, the adjustment of image quality including brightness adjustment.

3. The image processing apparatus according to claim 1,
the digital image data including plural color data including different colors, and the adjustment of image quality can be independently performed for each color.

4. A projector that projects image, comprising:
an image processing unit configured to execute image processing to original image data and to generate image data for a projector;
an image generating unit configured to generate an image to be projected based on the image data; and
a projection optical unit configured to project the image;
the image processing unit including;
an input unit configured to input digital image data;
a quality adjustment unit configured to execute an adjustment of image quality to the digital image data; and
a keystone correction unit configured to generate corrected image data so as to correct a keystone error, which occurs by a tilted projection of the projector, of the digital image data which is adjusted for image quality.

5. An image processing method for executing image processing of original image data, thereby generating image data for a projector, the image processing method comprising:
inputting digital image data;
executing an adjustment of image quality for the digital image data; and
generating corrected image data so as to correct a keystone error, which occurs by a tilted projection of the projector, of the digital image data which is adjusted for image quality.

6. A computer readable recording medium that stores a computer program to execute image processing of original image data, thereby generating image data for a projector, the computer program causes a computer to perform the following operations:
inputting digital image data;
executing adjustment of image quality for the digital image data; and
generating corrected image data so as to correct a keystone error, which occurs by a tilted projection of the projector, of the digital image data which is adjusted for image quality.
